(19) United States
(12) Patent Application Publication
(10) Pub. No.: US 2025/0113817 A1
(43) Pub. Date: Apr. 10, 2025

(54) Jimmy's Wildlife Feeder Defender

(71) Applicants: Jimmy Dale Henry, Huntsville, TX (US); Mary Dunseith Henry, Huntsville, TX (US)

(72) Inventors: Jimmy Dale Henry, Huntsville, TX (US); Mary Dunseith Henry, Huntsville, TX (US)

(21) Appl. No.: 18/482,575

(22) Filed: Oct. 6, 2023

(51) Int. Cl. A01M 29/30; A01M 17/00

(52) U.S. Cl. CPC A01M 29/30; A01M 17/00

(57) ABSTRACT

A static device with no moving parts to be used with game feeder equipment where by the invention is attached to the top of animal feeder tube troughs to keep undesired animals such as, but not limited to, Raccoons and Squirrels from gaining access to the top of feeder tube troughs and subsequently from gaining access to feed and or feedstocks.

This amended application for utility patent relates to and claims the benefits of U.S. Provisional Application No. 63/488,237, filed Mar. 3, 2023 and entitled “JIMMY′S WILDLIFE FEEDER DEFENDER,” the entire contents of which is expressly incorporated by reference.

### BACKGROUND OF THE INVENTION

### 1) Field of the Invention

The present invention relates to use of spikes protruding through a flexible base material that can be manipulated to fit on the top exterior of trough openings of game feeder apparatus as an affixed cover. Doing so prevents undesirable animals from climbing up onto the top of the trough and then gaining access into the trough. Preventing undesirable animals from entering the area of the feeder apparatus containing feed and feedstock materials protects the feed and feedstock and allows for consumption by the intended animal without interference or hindrance to the intended animal recipient.

### 2) Description of Related Art

Wild animal game feeders, such as those used in deer; elk; ram; antelope; goat and boar feed maintenance programs have common design features that consist of a storage area to contain grain or feedstocks, a gravity feed means to allow feed/feedstocks to drop down into feeder troughs, and feeder troughs that are open to provide access for the intended animal so that it may feed on the materials therein. These feeders also share common means of elevation primarily with three or four narrow metal legs that support the feed container. The feeder troughs can't be reached from the ground as they are suspended directly below the feed storage container. As such, undesired animals such as, but not limited exclusively to, raccoons climb the support legs and reach over and subsequently climb onto the top of the feed troughs and then enter the troughs and consume the feed or feedstocks. There is a strong demand for methodologies to protect feed and feedstock(s) placed to support and manage nutritional requirements of intended animals and prevent consumption or spoiling by undesired animal(s) breaching game feeder trough(s).

Current undesired animal deterrent systems utilized in preventing access to game feeder trough(s) have significant deficiencies, are designed to kill; maim; harm or frighten away undesired animals to protect the feed/feedstocks for the intended animals, and many require constant monitoring and attention.

Mechanical traps utilized to prevent undesired animal access to feeder troughs are ineffective as deterrent systems as the mechanical trap does not always capture or kill the undesired animal. When the undesired animal is caught but not killed immediately it results in a painful and drawn-out death or self-dismemberment. Further, traps that are triggered, regardless of capture or miss, then require re-setting. Trapped animals that are killed but not removed before decomposing drives intended game away, as would the cries and death throes of trapped animals not immediately killed.

Electrical deterrents designed to keep undesired animals away from, or from entering into, feed troughs require a constant power source and result in many of the same problems mechanical traps demonstrate. Electrical shock of significant amperage is harmful to all mammals, including the target animals that are to benefit from the feed/feedstocks in the feeder troughs. Electrical shock of significant voltage is not lethal in and of itself but the undesired animal reaction may often result in serious injury thus preventing it from leaving the immediate area and subsequently disturbing the intended animals from feeding. Further, it is difficult to arrange an electrical deterrent that does not risk electrical shock to the intended animal.

Poisoning deterrents to prevent undesired animal intrusion into feed troughs carries significant risk to all animals in the area of the poison, including animals that are supported by the feed program. Further, poisoning is not a quick or efficient methodology to eliminate or eradicate the undesired animal that may still access the trough.

Sound deterrents to prevent undesired animal intrusion into feed troughs require several component parts to include a motion detection device, a sound generator and a power source. Loud sounds have proven to stress larger animals more so than smaller animals, which is typically the nature of the undesired animal(s).

Scenting deterrents to prevent undesired animal intrusion into feed troughs using predator urine around the game feeder apparatus frighten the intended animal but does not frighten small mammals such as, but not limited to, raccoons and squirrels.

Preventing undesired animal intrusion into feed troughs with noxious chemicals, in either liquid or solid form, will also drive away the intended game animal. Noxious chemicals are controlled substances and in most instances are not legal for the unlicensed lay-person to acquire or utilize.

Accordingly, it is an object of the present invention to provide a spiked cover that fits on the top of feeder troughs to prevent undesired animal(s) from gaining access to the top of the trough.

### SUMMARY OF THE INVENTION

The above objectives are accomplished according to the present invention by providing a mat spiked with 2D nails hereafter a “spiked mat” that has no moving parts; uses no mechanical; no potential energy to power; no electrical energy to power; creates no sound or noise; is non-toxic; and does not pollute. 2D nails are one inch long and hereafter referred to as either spikes or nails.

In a further advantageous attribute, the present invention requires no monitoring or scheduled maintenance.

In a further advantageous embodiment, the present invention stops the theft or spoiling of feed or feedstock by undesired animals because of the sharp points of the spikes that would come into contact with the feet/claws, body parts of the undesired animals should undesired animals attempt jumping or climbing onto the top of the feeder troughs. The present invention causes no permanent physical harm to undesired animals.

In a further advantageous embodiment, the present invention uses a base material of fluted Polypropylene measuring 0.157 inches in thickness, 18 inches in length and 8 inches in width. The material is flexible and easy to cut to meet the dimensions of the specific feeder trough it will be applied to.

In a further advantageous embodiment the present invention utilizes a design for inserting the spikes that is accomplished by drawing a grid consisting of horizontal and vertical intersecting lines to provide for spacing between ¼ to ⅛ inches at each juncture of lines on the back of the base material, with the back being the side that will face down on the top of the trough. The 2D nails, hereafter also known as “spikes”, are then pushed through at the intersection of lines forming the grid pattern, and the spikes are further held in place by surface tension created when the spike is pushed through the fluted Polypropylene base material.

In a further advantageous embodiment regarding the present invention, the base with spikes protruding through it is then fitted to the top of the feeder trough and may be attached either in a flat configuration or in a slightly curved configuration, depending on the construction of the specific feeder trough, to make the best contact with the top of the trough.

In a further advantageous embodiment the present invention the invention may be affixed with the use of commercially available UV Resistant Long Cable Zip® Ties, 30-inch lengths, cut to size and laced on top of the mat between the rows of spikes and then looped around the trough and tightened firmly to secure the invention in place.

It is a further object of the present invention to provide a spiked cover that fits on top of the feeder trough(s) and that may be held in place with commercially available construction adhesive applied by the user before placing the spiked mat on top of the trough(s).

It will be understood by those skilled in the art that one or more aspects of this invention can meet certain objectives, while one or more other aspects can meet certain other objectives. Each objective may not apply equally, in all its respects, to every aspect of this invention. As such, the proceeding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### BRIEF DESCRIPTION OF THE DRAWINGS

All previous drawings submitted with the original application are herein deleted in their entirety and replaced with amended drawings identified as being “Replacement Sheet” ¼; “Replacement Sheet” 2/4; “Replacement Sheet” ¾ and “Replacement Sheet” 4/4. The system designed for use of the invention will herein be described, together with other features thereof. The invention will be more readily understood from a reading of the following specification and by reference to the accompanying amended drawings forming a part thereof, wherein an example of the invention is shown and wherein:

FIG. 1 shows a deer feeding apparatus with the invention in place on the feeder troughs;

FIG. 2 shows the invention in a vertical position with the bottom, face-down position facing the reader. It also shows the spikes in place;

FIG. 3a shows the invention bottom side facing the reader;

FIG. 3b shows the invention top side facing the reader;

FIG. 3c shows a side view of the spikes;

FIG. 4a shows a frontal view of an open trough with the invention affixed by strap; and,

FIG. 4b shows a frontal view of an open trough with the invention affixed by adhesive.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing form the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be dawn therefrom, alone or with consideration of the references incorporated herein.

### DETAILED DESCRIPTION OF A PREFERRED EMBODIMENT

With reference to the amended drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

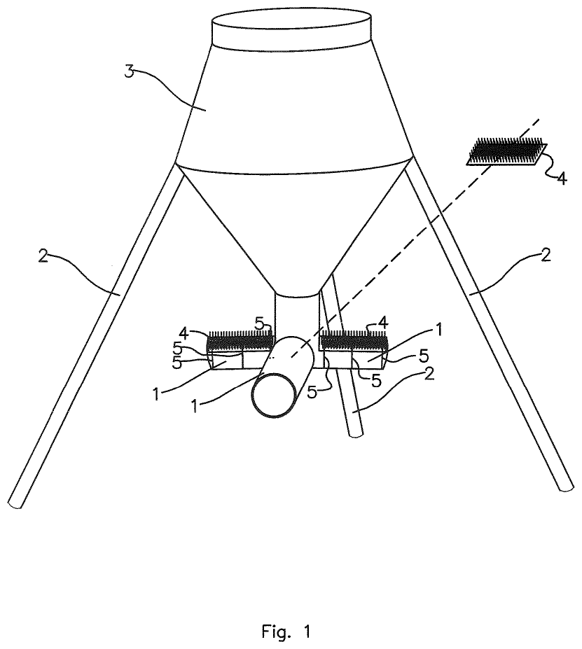

As shown in FIGS. 1-4 on their respective drawing sheets, example embodiments are shown of Jimmy's Wildlife Feeder Defender, designated generally as 4, which is placed on the top of the animal feeder tube troughs. Jimmy's Wildlife Feeder Defender conforms to the top of the feed tube trough and may be configured as a rectangle or semi-circular format to best fit the specific top of the feeder tube trough. Jimmy's Wildlife Feeder Defender is flexible and can easily be shaped by hand to fit the dimensions of the feeder troughs. Jimmy's Wildlife Feeder Defender can be utilized on any dimension feeder trough, does not require any modification of feeder troughs and can easily be removed if so desired.

Referring to FIG. 1, Replacement Sheet ¼, in an illustrated embodiment, Jimmy's Wildlife Feeder Defender 4 is shown in the upper right of FIG. 1 and is shown moving toward the top of the feeder tube trough 1 for placement on top of the feeder tube trough 1. FIG. 1 also shows the other feeder troughs 1 with Jimmy's Wildlife Feeder Defender 4 held in place with UV Resistant Long Cable® Tie 5 to the top of the respective troughs. The feeder storage container 3 and feeder unit support legs 2 are not involved in the placement of Jimmy's Wildlife Feeder Defender 4. FIG. 1 should be used by USPTO for publication purposes.

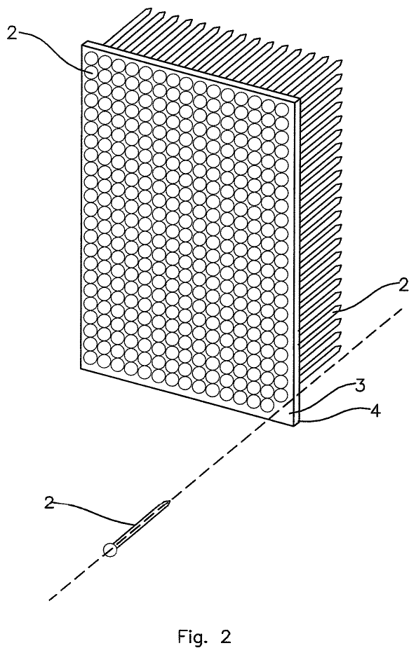

Referring to FIG. 2, Replacement Sheet 2/4, in an illustrated embodiment where a vertical illustration of Jimmy's Wildlife Feeder Defender 4 is shown facing the reader from the bottom side, the spikes 2 being inserted through the polypropylene base 3 with the heads of the spikes 2 holding the spikes 2 in place within the polypropylene base 3 by surface tension.

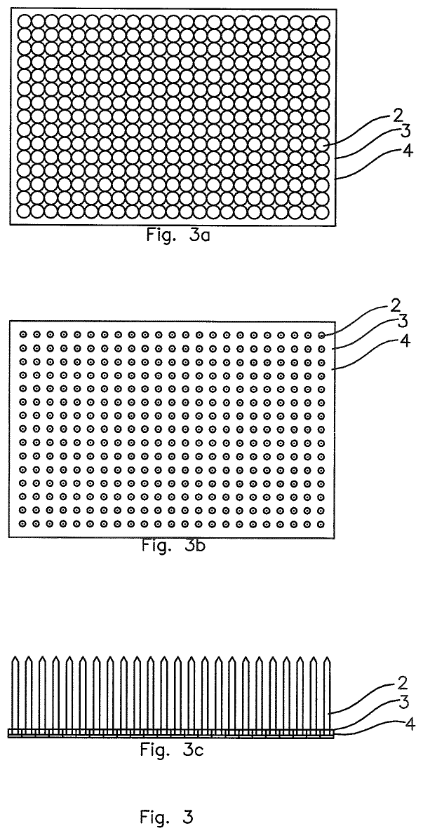

Referring to FIG. 3a, Replacement Sheet ¾, in an illustrated embodiment where vertical illustration of Jimmy's Wildlife Feeder Defender 4 is shown facing the reader from the bottom side, the spikes 2 pattern after being inserted through the polypropylene base 3 is observed, showing the head of the spikes 2 after the spikes 2 have been inserted into and through the polypropylene base 3.

Referring to FIG. 3b, Replacement Sheet ¾, in an illustrated embodiment where a vertical illustration of Jimmy's Wildlife Feeder Defender 4 is shown facing the reader from the top side, the spikes 2 pointed pattern after the sharp point was inserted through the polypropylene base 3 is shown. This illustration demonstrates that the spikes 2 pattern prevents undesired animals from evading the sharp points of spikes 2.

Referring to FIG. 3c, Replacement Sheet ¾, in an illustrated embodiment where a horizontal illustration of Jimmy's Wildlife Feeder Defender 4 is shown facing the reader from a side perspective, the spikes 2 are shown vertically after insertion through the polypropylene base 3 and demonstrate that the pattern as previously described being based upon spike 2 insertion at the juncture of intersecting lines prevents undesired animals from evading the sharp points of spikes 2.

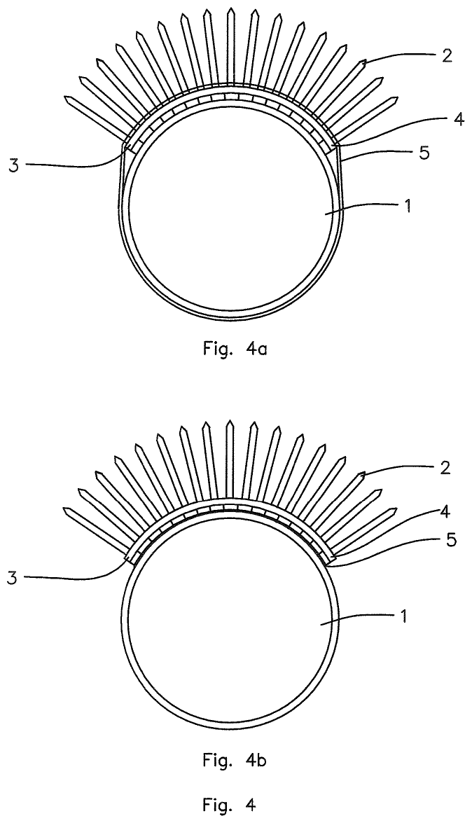

Referring to FIG. 4a, Replacement Sheet 4/4, in an illustrated embodiment where a vertical view illustrates the front opening of the feeder tube trough 1 with Jimmy's Wildlife Feeder Defender 4 in position with spikes 2 being vertical, and polypropylene base 3 being bottom side down on the top of feeder tube trough 1, held in place with UV Resistant Long Cable® Ties 5. It is noted that spikes 2 are held in position by surface tension achieved when polypropylene base 3 is punctured but then further secured by surface pressure achieved when the bottom of Jimmy's Wildlife Feeder Defender 4 is secured to the top of feeder tube trough 1 by means of tension tightening of the UV Resistant Long Cable® Ties 5.

Referring to FIG. 4b, Replacement Sheet 4/4, in an illustrated embodiment where a vertical view illustrates the front opening of the feeder tube trough 1 with Jimmy's Wildlife Feeder Defender 4 in position with spikes 2 being vertical, and polypropylene base 3 being bottom side down on the top of feeder tube trough 1, held in place with construction adhesive 5. It is noted that spikes 2 are held in position by surface tension achieved when polypropylene base 3 is punctured but then further secured by surface pressure achieved when the bottom of Jimmy's Wildlife Feeder Defender 4 is affixed with the use of construction adhesive 6 to the top of feeder tube trough 1.

1. The invention could be utilized as a wraparound for electrical component(s) and wiring(s) to prevent animal chewing of insulation covers for mechanical, electrical or structural components.

The invention could be used to protect electrical insulation on such items as electrical transmission equipment; transformers; substation regulators; power lines and associated wiring harnesses attractive to animals.

The invention can prevent varmint intrusion into the eaves of structures.

The invention can prevent varmint access to food stock (human or animal) storage areas.

The invention can prevent varmint access to areas where consumables (oils, shortening; vegetable plantings, seeds and so forth) and non-consumables (cloth, raw materials, cotton and the like) are stored.

The invention can prevent varmint access to areas where medicines, drugs, health and emergency supplies and appliances are stored.

The invention can prevent varmints from climbing poles; gutter downspouts; utility lifts; building walls and abutting's; structures and vehicles.

The invention can prevent varmints from climbing window frames; door frames; chimneys; exhaust pipes and lintels.

The invention can prevent varmint access through holes in exterior walls or exterior openings for venting or drainage.

The invention can prevent varmints from gaining access through foundation voids; holes; venting slots; pipes or other accessories entering walls from outside.

The invention can be fashioned as a collar of varying circumferences around pipes; it can be fashioned to fit small equipment components such as hoses; voltage regulators; pumps; motors; communication devices; frames and casing.

The invention can prevent varmints from accessing or trespassing into anything that the invention can be affixed to.

The invention can be utilized to prevent varmint access to any item on a stand of any type; from climbing bird feeders; from entry into landscaped or garden areas and as a maze to guide varmints away from areas attractive to the varmint(s).

The invention can be used to prevent varmints from accessing insulation on heavy equipment; vehicles; machinery; farm and agricultural equipment; ranch trucks and vehicles; and aircraft.

The invention can be used to quarantine animals.

The invention can prevent animal climbing of tree trunks to protect fruits, nuts and habitat.
